(19) United States
(12) Patent Application Publication
(10) Pub. No.: US 2010/0244513 A1
(43) Pub. Date: Sep. 30, 2010

(54) VEHICLE SEAT

(75) Inventors: Osamu FUKUI, Ninomiya-machi (JP); Keisuke HAYAMA, Ayase-shi (JP)

Correspondence Address: GLOBAL IP COUNSELORS, LLP, 1233 20TH STREET, NW, SUITE 700, WASHINGTON, DC, 20036-2680, US

(73) Assignee: AUTECH JAPAN, INC., Chigasaki-shi (JP)

(21) Appl. No.: 12/700,919

(22) Filed: Feb. 5, 2010

(30) Foreign Application Priority Data
Mar. 24, 2009 (JP) 2009-071104

(51) Int. Cl. B60N 2/02; A47C 7/62; B60N 2/20; B62D 1/18

(52) U.S. Cl. 297/217.1; 297/314

(57) ABSTRACT

A vehicle seat is adapted to be disposed adjacent to an entrance/exit opening of a vehicle, the vehicle seat includes a seat main body and a tilting mechanism. The seat main body includes a sitting surface. The tilting mechanism is configured and arranged to selectively tilt the sitting surface about a rotational axis with the rotational axis being arranged diagonally with respect to a front-rear direction of the vehicle seat such that a lateral frontward portion of the sitting surface to be located closer to the entrance/exit opening of the vehicle is lowered when the sitting surface is tilted.

### CROSS-REFERENCE TO RELATED APPLICATIONS

This application claims priority to Japanese Patent Application No. 2009-071104 filed on Mar. 24, 2009. The entire disclosure of Japanese Patent Application No. 2009-071104 is hereby incorporated herein by reference.

### BACKGROUND

1. Field of the Invention

The present invention relates to a vehicle seat configured to be installed in a vehicle.

2. Background Information

A vehicle seat equipped with a device serving to improve the ability for a person to get into and out of a vehicle is known.

A known example of such a vehicle seat is configured to turn toward an entrance/exit opening and lower a frontward end of a seat cushion of the set when a person is entering or exiting the vehicle (e.g., Japanese Laid-Open Patent Publication No. 2008-114670).

A vehicle seat like that just described requires a seat rotation operation and a seat tilting operation and it is necessary to rotate the seat while lowering the front end of the seat cushion. Consequently, it has been a challenge to simplify the mechanical aspects (mechanisms) of the vehicle seat.

Meanwhile, a vehicle seat configured to tilt a sitting surface of a seat cushion outward is also known (e.g., Japanese Laid-Open Patent Publication No. 2001-277913).

### SUMMARY

With the existing vehicle seat described above, it is necessary to tilt the sitting surface of the seat after a sitting person has placed his or her feet outside the vehicle because the vehicle seat is configured to tilt the entire sitting surface outward.

Thus, the vehicle seat does not serve to improve the ease of placing one's feet outside the vehicle.

The present invention was conceived in view of the issues of the existing art described above and its object is to provide a vehicle seat that is simpler mechanically and can improve the ease with which a person sitting on the vehicle seat can place his or her feet outside the vehicle.

In order to achieve the aforementioned object, a vehicle seat adapted to be disposed adjacent to an entrance/exit opening of a vehicle includes a seat main body and a tilting mechanism. The seat main body includes a sitting surface. The tilting mechanism is configured and arranged to selectively tilt the sitting surface about a rotational axis with the rotational axis being arranged diagonally with respect to a front-rear direction of the vehicle seat such that a lateral frontward portion of the sitting surface to be located closer to the entrance/exit opening of the vehicle is lowered when the sitting surface is tilted.

As a result, a distance from the lateral frontward portion of the vehicle seat (from which a seated person's legs will extend) to a road surface is reduced.

Additionally, a bulged portion typically provided on a side portion of the sitting surface of a vehicle seat can be lowered, and a sitting surface angle set in a longitudinal direction of the sitting surface such that a front portion of the sitting surface will be higher can be made smaller.

Thus, it is easer for a person sitting on the sitting surface to lift himself or herself off the sitting surface (i.e., get up from the sitting surface) and it is easier for a person to put himself or herself onto the sitting surface than with a vehicle seat that is not configured to move a lateral frontward portion of the sitting surface.

### BRIEF DESCRIPTION OF THE DRAWINGS

Referring now to the attached drawings which form a part of this original disclosure:

FIG. 1 is a perspective view of a vehicle seat according to a first embodiment of the present invention.

FIG. 2 is a plan view of the vehicle seat according to the first embodiment with a portion depicted as though it is transparent.

FIG. 3 includes perspective views of a tilting mechanism of the vehicle seat according to the first embodiment with a diagram (a) being a perspective view seen from above and a diagram (b) being a perspective view seen from underneath.

FIG. 4 includes partial views of the vehicle seat seen from the direction of the arrow A shown in FIG. 2 according to the first embodiment with a diagram (a) illustrating a tilted state and a diagram (b) illustrating a normal.

FIG. 5 is a flowchart showing the operations executed in the first embodiment.

FIG. 6 includes schematic views of a portion of a vehicle including the vehicle seat in a tilted state according to the first embodiment with a diagram (a) being a frontal view and a diagram (b) being a side view.

FIG. 7 includes plan views of the tilting mechanism as seen from the direction of the arrow B shown in FIG. 2 with a diagram (a) illustrating the first embodiment and a diagram (b) illustrating a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

The embodiment will now be explained with reference to the drawings.

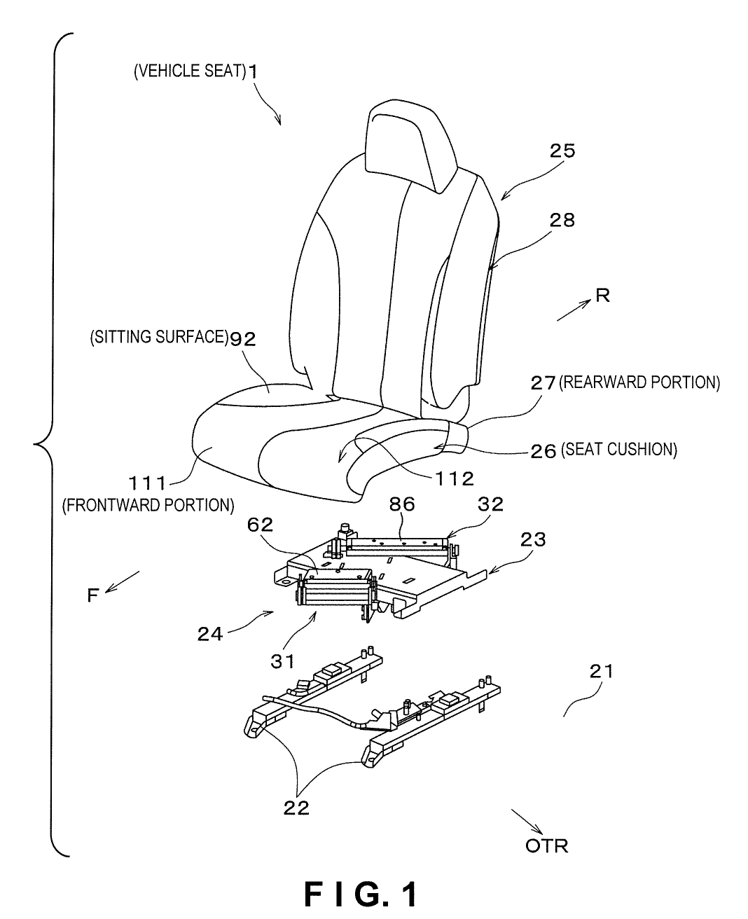

FIG. 1 shows a vehicle seat 1 according to the first embodiment. As an example, this embodiment will be explained based on a case in which the vehicle seat 1 is installed as a passenger seat on the left side of an automobile.

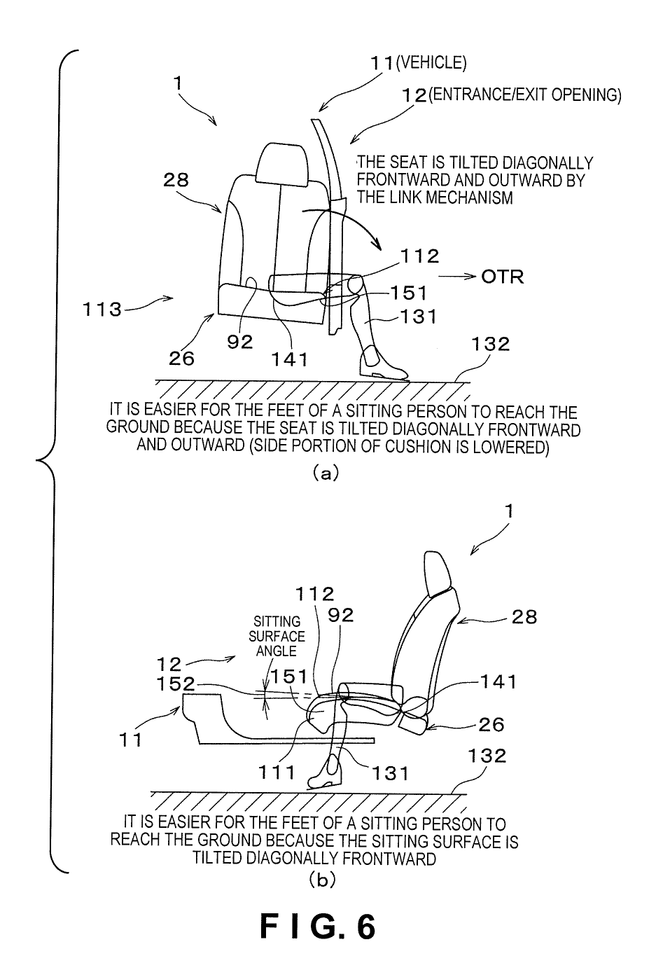

An entrance/exit opening 12 for the passenger seat is provided on a left side portion of the vehicle 11 (see FIG. 6) and the vehicle seat 1 is arranged along side the entrance/exit opening 12.

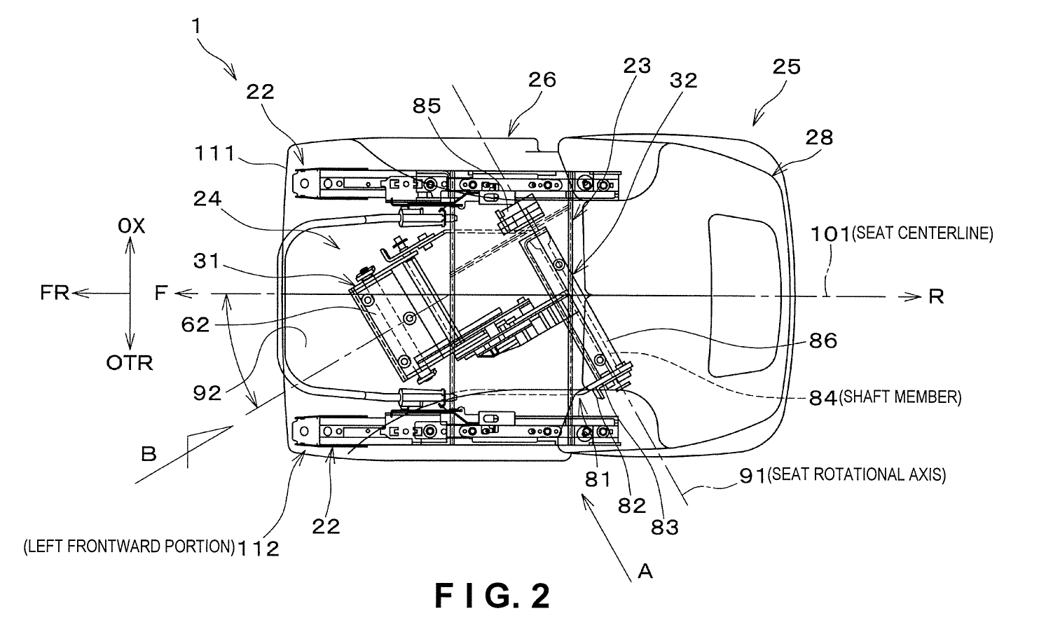

As shown in FIG. 1, two slide rails 22 and 22 oriented along a longitudinal direction of the vehicle are provided on a floor panel 21 of the vehicle 11 and a slider 23 is slidably supported on the slide rails 22. A tilting mechanism 24 is provided on the slider 23 and, as shown in FIGS. 1 and 2, a seat main body 25 is supported on the slider 23 through the tilting mechanism 24. The seat main body 25 comprises a seat cushion 26 that forms a sitting surface and a seat back 28 that is provided on a rearward portion 27 of the seat cushion 26 and forms a surface on which to rest one's back.

The tilting mechanism 24 comprises a link mechanism 31 arranged and configured to extend beyond the slider 23 in a frontward direction F (i.e., a direction oriented toward the front of the seat) and a rotation mechanism 32 provided on a rearward side of the slider 23, i.e., in a rearward direction R of the seat relative to the link mechanism 31.

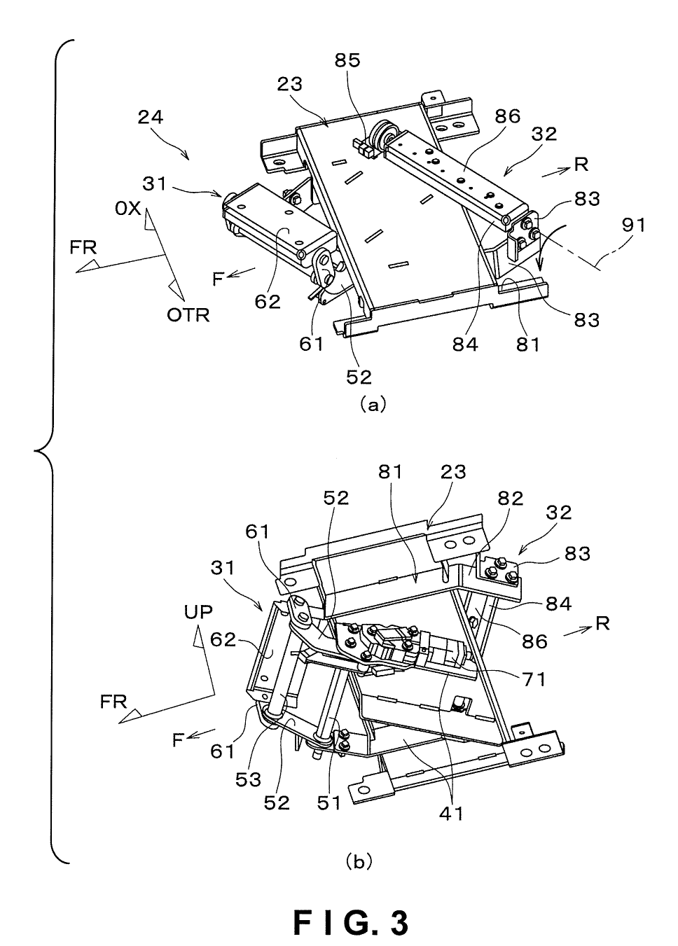

As shown in FIG. 3(b), the link mechanism 31 has a pair of front support brackets 41 and 41 fastened to a bottom surface of the slider 23. The front support brackets 41 and 41 extend beyond a front edge of the slider 23 in the frontward direction F and are arranged to be slanted in a leftward direction (outward) of the vehicle (see FIG. 3(a)).

A first coupling rod 51 is arranged to span between tip end portions of the front support brackets 41, and base end portions of two first link arms 52 and 52 are turnably supported on the end portions of the first coupling rod 51. Each of the first link arms 52 comprises a plate-like member having an obtuse V-like shape. A second coupling rod 53 is arranged is arranged to span between tip end portions of the first link arms 52.

Base end portions of two second link arms 61 and 61 are turnably supported on the end portions of the second coupling rod 53. A front fastening bracket 62 fastened to a frontward end portion of the seat cushion 26 is arranged to span between tip end portions of the second link arms 61 and to be turnably supported on the same tip end portions.

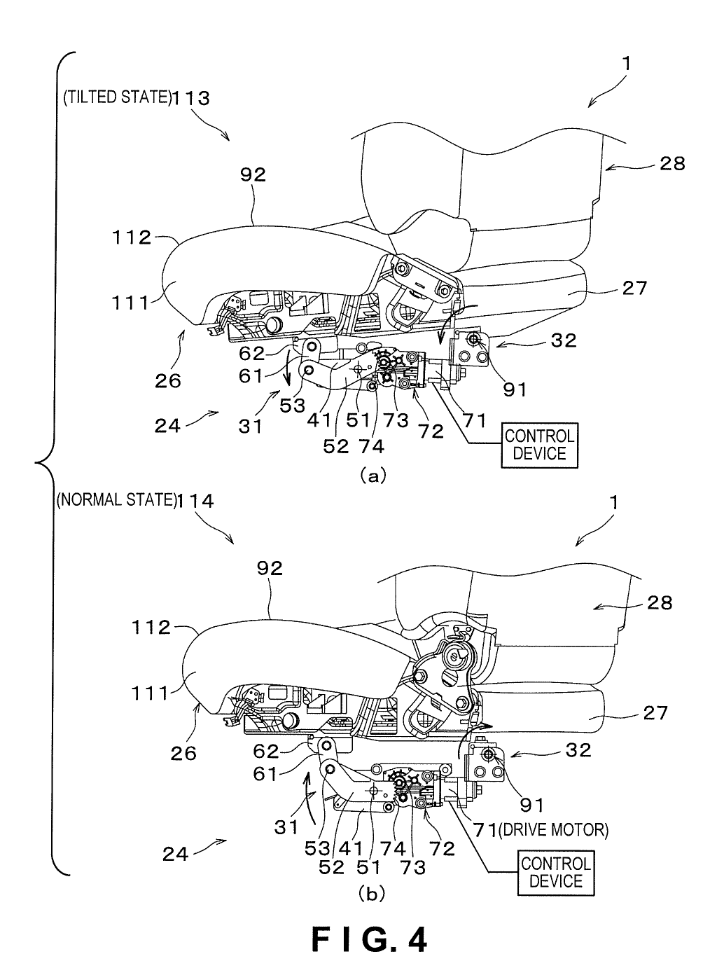

As shown in FIG. 3(b) and FIG. 4, a drive motor 71 constituting a drive device is provided on a side face of the front support bracket 41 provided on the left side of the slider 23. As shown in FIG. 4, output from the drive motor 71 is transmitted to a pinion gear 73 through a reduction gear 72. The pinion gear 73 is arranged and configured to mesh with a gear section 74 provided on the base end of the first link arm 52 provided on the left-hand side.

Thus, by moving the tip end portions of the first link arms 52 and 52 up and down by turning the left-hand first link arm 52 with the drive motor 71, the second link arms 61 and 61 connected to the tip end portions of the first link arms 52 and 52 can by moved up and down, thereby moving the front fastening bracket 62 arranged on the tip ends of the second link arms 61 and 61 up and down. As a result, a frontward portion of the seat cushion 26, which is supported on the front fastening bracket 62, can be moved up and down.

As shown in FIG. 3(b), a rear support bracket 81 is provided on the bottom surface of the slider 23. The rear support bracket 81 protrudes beyond a left rear edge of the slider 23 in the rearward direction R of the seat. As shown in FIG. 3(a), a rearward end portion 82 of the rear support bracket 81 is bend rightward, i.e., toward a centerline of the vehicle so as to form an obtuse V-like shape. A shaft member support bracket 83 is fastened to the rearward end portion 82. As shown in FIG. 2, one end of a circular rod-shaped shaft member 84 is rotatably supported on the shaft member support bracket 83 and the other end of the shaft member 84 is rotatably supported on a standing bracket 85 provided on an upper surface of the slider 23. A rear fastening bracket 86 fastened to a rearward end portion of the seat cushion 26 is supported on the shaft member 84.

In this way, as shown in FIG. 2, the seat main body 1 (which includes the seat cushion 26) is configured to tilt about a seat rotational axis 91 corresponding to a center axis of the shaft member 84 such that a sitting surface 92 formed by the seat cushion 26 can be tilted (see FIG. 1).

As shown in FIG. 2, the seat rotational axis 91 established by the shaft member 84 supported on the rear fastening bracket 86 intersects diagonally with a seat centerline 101 extending in a longitudinal direction (front to back) of the sitting surface 92. The front fastening bracket 62 is also arranged to intersect diagonally with the seat centerline 101 such that the rear fastening bracket 84 supported along the seat rotational axis 91 and the front fastening bracket 62 are arranged parallel to each other. The seat rotational axis 91 is oriented such that it slants toward the rearward direction R of the seat as it approaches the leftward (outward) direction and toward the frontward direction F as it approaches the centerline of the vehicle.

As a result, when a frontward portion 111 of the seat cushion 26 is lowered by the link mechanism 31, a tilted state 113 is achieved in which a left frontward portion 112 comprising a portion of the frontward portion 111 of the sitting surface 92 located closer to the entrance/exit opening 12 is lowered as shown in FIGS. 1, 2, and 4. As shown in FIG. 4, when the vehicle seat is in the tilted state 113, a lower position switch (not shown) provided on the arms 52, 52, 61, and 61 of the tilting mechanism 24 turns on. Meanwhile, when the link mechanism 31 raises the frontward portion 111 of the seat cushion 26, a normal state 114 is achieved in which the left frontward portion 112 of the sitting surface 92 is returned to a normal height position and an upper position switch (not shown) provided on the arms 52, 52, 61, and 61 of the tilting mechanism 24 turns on.

When the vehicle seat is in the tilted state 113, a portion of the seat cushion 26 located in the rearward direction R from a position where the seat cushion 26 is supported by the rear fastening bracket 86 is raised. Thus, compared to a vehicle seat in which the seat rotational axis 91 is established on a rearward edge portion of the seat cushion 26, the amount by which the frontward portion 111 of the seat cushion 26 is lowered can be suppressed while still enabling to the sitting surface 92 to be tilted by a large tilt angle.

The drive motor 71, the aforementioned switches, and a vehicle mounted door switch provided on the entrance/exit opening 12 to detect an open/closed state of the door are connected to a control device (FIG. 4). The control device includes, for example, a microcomputer.

The control device is also preferably operatively coupled to such existing and conventional mechanisms as a sliding mechanism (including the slide rails 22) configured to slide the seat main body 25, a reclining mechanism configured to recline the seat back 28 of the seat main body 25, and a steering tilt mechanism configured to change an angle of a steering wheel of the vehicle when the sitting surface 92 of the vehicle seat is tilted.

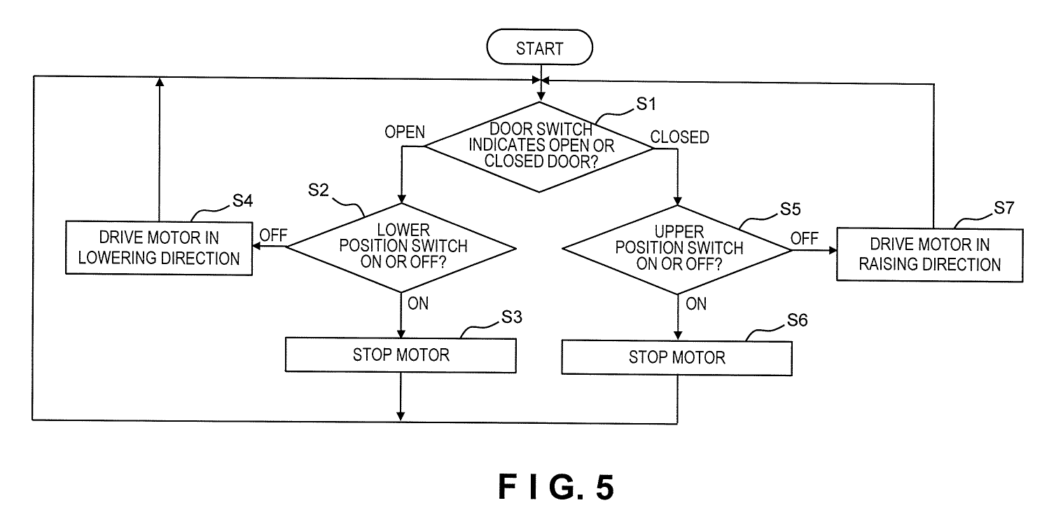

The operation of the embodiment described heretofore will now be explained with reference to the flowchart of FIG. 5.

When the microcomputer of the aforementioned control device starts executing a program stored in an internal ROM, it first detects the status of the door switch (S1). If the door has been opened from a state in which the entrance/exit opening 12 was closed by the door and a signal indicating that the door is open is issued from the door switch, then the control device detects the status of the lower position switch (S2).

If the frontward portion 111 of the seat cushion 26 has been lowered by the link mechanism 31 until the tilted state 113 (in which a left frontward portion 112 of the sitting surface 92 has been lowered to a low position) has been achieved, then the lower position switch is on and the control device shuts off the supply of power to the drive motor 71 in order to stop the link mechanism from lowering the sitting surface 92 any further (S3).

The lower position switch is in an off state when the link mechanism 31 has raised the frontward portion 11 of the seat cushion 26 to the normal state 114 (in which the left frontward portion 112 of the sitting surface 92 is at a normal height) or the frontward portion 11 is in a position between the tilted state 113 and the normal state 114. If the lower position switch is off, then the control device drives the drive motor 71 in a lowering direction such that the left frontward portion 112 of the sitting surface 92 is lowered (S4). The control device then stops the link mechanism 31 from tilting the sitting surface 92 when the tilted state 113 is reached.

Thus, when the door is opened, the left frontward portion 112 of the sitting surface 92 formed by the seat cushion 26 is lowered to a low position so as to achieve the tilted state 113 shown in FIG. 4(a) and FIG. 6.

Meanwhile, in step S1, if the door has been closed from a state in which the entrance/exit opening 12 was open and a signal indicating that the door is closed is issued from the door switch, then the control device detects the status of the upper position switch (S5).

If the frontward portion 111 of the seat cushion 26 has been raised by the link mechanism 31 until the normal state 114 (in which a left frontward portion 112 of the sitting surface 92 has been returned to a normal height position) has been achieved, then the upper position switch is on and the control device shuts off the supply of power to the drive motor 71 in order to stop the link mechanism 31 from raising the sitting surface 92 any further (S6).

The upper position switch is in an off state when the link mechanism 31 has lowered the frontward portion 11 of the seat cushion 26 to the tilted state 113 (in which the left frontward portion 112 of the sitting surface 92 is in a low position) or the frontward portion 11 is in a position between the tilted state 113 and the normal state 114. If the upper position switch is off, then the control device drives the drive motor 71 in a raising direction such that the left frontward portion 112 of the sitting surface 92 is raised (S7). The control device then stops the link mechanism 31 from tilting the sitting surface 92 when the normal state 114 is reached.

Thus, when the door is closed, the left frontward portion 112 of the sitting surface 92 formed by the seat cushion 26 is returned to a normal height position so as to achieve the normal state 114 shown in FIG. 4(b).

In this embodiment, since the seat rotational axis 91 about which the sitting surface 92 tilts is set to be diagonal with respect to a seat centerline 101 extending in a longitudinal direction of the sitting surface, a left frontward portion 112 comprising a portion of a frontward portion 111 of the sitting surface 92 located closer to the entrance/exit opening 12 can lowered by tilting the sitting surface 92 such that the frontward portion 111 is lowered.

As a result, a distance from the left frontward portion 112 (from which the legs 131 of a seated person will extend) to a road surface 132 can reduced such that the feet of a person getting out of the vehicle can reach the ground more easily.

With a conventional structure in which an entire lateral portion of the sitting surface 92 of the vehicle seat is lowered toward the entrance/exit opening 12, a rearward portion of the sitting surface 92 where a hip point 141 is positioned is also tilted toward the entrance/exit opening 12. Consequently, the sitting surface 92 cannot be tilted until the sitting person's legs 131 have been placed outside the vehicle cabin. Conversely, with this embodiment, since the portion of the sitting surface 92 that is lowered is a left frontward portion 112 comprising a portion of a frontward portion 111 located closer to the entrance/exit opening 12 of the vehicle, it is easier for a sitting person to maintain a sitting posture when the sitting surface is tilted and the person can place his or her legs 131 outside the vehicle cabin after the sitting surface 92 has been tilted.

Additionally, as shown in FIG. 6(b), a bulged portion 151 typically provided on a side portion of the sitting surface 92 of a vehicle seat can be lowered, and a sitting surface angle 152 set such that the frontward portion 111 will be higher can be made smaller at the left frontward portion 112. As a result, the ease with which a sitting person can move his or her legs out through the entrance/exit opening 12 can be improved.

In addition to improving the ease with which a person sitting on the sitting surface 92 of the vehicle seat can get up from the sitting surface 92, the embodiment can also improve the ease with which a person can get into the vehicle seat, i.e., sit on the sitting surface 92, in comparison with a vehicle seat that is not contrived such that a height position of a left frontward portion 112 can be changed.

By simply configuring the vehicle seat 1 such that the seat rotational axis 91 about which the sitting surface 92 tilts is diagonal with respect to a seat centerline 101 oriented in a longitudinal direction of the sitting surface 92, the vehicle seat 1 can make it easier for a sitting person to move his or her legs out through the entrance/exit opening and easier for the feet of a person getting out of the vehicle to reach the ground without the need to provide a rotation mechanism and a tilt mechanism configured to operate together in a coordinated fashion.

Thus, a vehicle seat 1 according to this embodiment is simpler mechanically, can be less expensive, and can improve the ease with which a person sitting on the vehicle seat can place his or her feet outside the vehicle.

Since the vehicle seat 1 is simpler mechanically, it can also be configured to be lighter in weight and, thereby, contribute to improving the fuel efficiency of a vehicle 11 in which the vehicle seat 1 is installed.

Since the seat main body 25 does not move to a position outside the vehicle cabin, it is not necessary to open the door provided in the entrance/exit opening 12 widely and the functions described above can be accomplished sufficiently even when only a small amount of space is available.

Since the amount of movement of the sitting surface 92 is small, the movement can be completed in a short amount of time and a person can get into and out of the vehicle quickly.

Since the movement direction of the sitting surface 92 is limited to rotation about the aforementioned seat rotational axis 91, a strong structure having little excess play can be achieved comparatively easily.

Additionally, the sitting surface 92 can be moved between a normal state 114 and a tilted state 113 by simply opening and closing a door installed in the entrance/exit opening 12.

Since the sitting surface 92 can be tilted and returned in coordination with opening and closing the door, the tilting function can be used without performing such separate operations as turning a switch on and off, thus making the vehicle seat more convenient.

A tilted state 113 in which the lateral frontward portion 112 of the sitting surface 92 is lower can be achieved by raising a rearward portion 27 of the sitting surface 92.

Thus, the sitting surface 92 can be tilted to a large tilt angle while suppressing the amount by which a frontward end portion of the seat cushion 26 is lowered in comparison with a vehicle seat in which the seat rotational axis 91 is arranged on a rearward edge portion of the seat cushion 26.

As a result, this embodiment can be applied even to a vehicle 11 in which the sitting surface 92 is low and the left frontward section 112 cannot be lowered by a large amount.

It is also possible to provide the link mechanism 31 in a position closer to a rearward portion (in the rearward direction R) of the vehicle seat and provide the seat rotational axis 91 in a position closer to a frontward portion (in the frontward direction F) of the vehicle seat. In such a case, the left frontward portion 112 of the sitting surface 92 can be lowered by raising a rearward portion 27 of the sitting surface 92.

A vehicle seat according to this embodiment is also equipped with a control device for controlling such existing mechanisms as a sliding mechanism configured to slide the seat main body 25, a reclining mechanism configured to recline the seat back 28 of the seat main body 25, and a steering tilt mechanism configured to change an angle of a steering wheel of the vehicle when the sitting surface 92 is tilted.

Thus, when the sitting surface 92 is tilted, the existing mechanisms can be controlled so as to prevent interference between the seat main body 25 and the existing mechanisms.

With a vehicle seat according to claim 4, a frontward portion of the sitting surface of the vehicle seat can be turned toward the entrance/exit opening in response to the lateral frontward portion of the sitting surface being lowered.

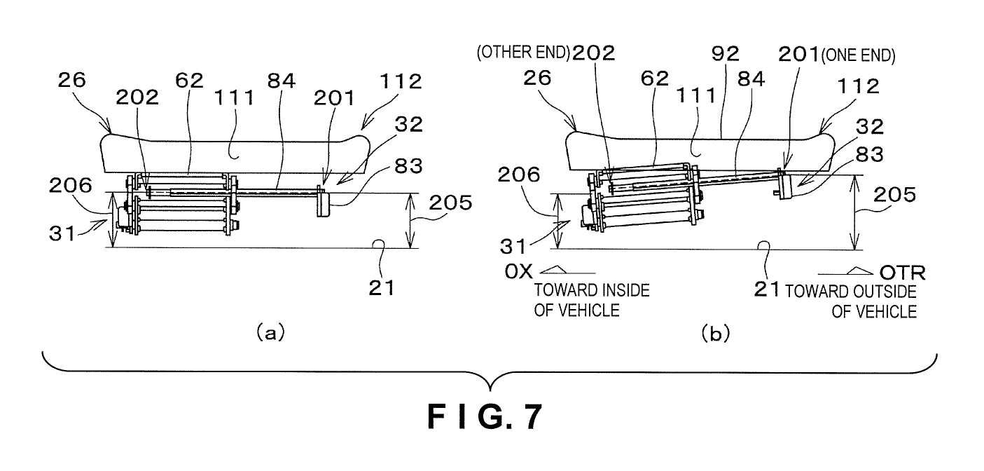

Although this embodiment is explained based on a case in which, as shown in FIG. 7(a), the shaft member 84 of the rotation mechanism 32 is arranged to be parallel to the floor panel 21, the invention is not limited to such an arrangement.

### Second Embodiment

Referring now to FIG. 7(b), a vehicle seat in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the second embodiment, as shown in FIG. 7(b), the shaft member 84 is vertically slanted with respect to the floor panel 21 such that one end 201 of the shaft member 84 positioned nearer the entrance/exit opening 12 is higher than the other end 202 of the shaft member 84, which is positioned nearer the center of the vehicle. In other words, a height position 205 of the one end 201 with respect to the floor panel 21 is higher than a height position 206 of the other end 202 with respect to the floor panel 21. The link mechanism 31 is slanted at substantially the same slope as the shaft member 84.

With this embodiment, the frontward portion 111 of the sitting surface 92 can be turned toward the entrance/exit opening 12 when the left frontward portion 112 of the sitting surface 92 is lowered.

As a result, in comparison with a vehicle seat that requires a person to turn the body by a large amount in order to sit on the sitting surface 92 or exit through the entrance/exit opening, a vehicle seat according to this embodiment can reduce the burden born by the body of a person attempting to sit in the vehicle seat or get out of the vehicle seat because the amount by which the person must rotate his or her body is reduced.

According to the embodiments described above, the vehicle seat 1 is adapted to be disposed adjacent to the entrance/exit opening 12 of a vehicle. The vehicle seat 1 includes the seat main body 25 including the sitting surface 92, and the tilting mechanism 24 configured and arranged to selectively tilt the sitting surface 92 about the rotational axis 91 with the rotational axis 91 being arranged diagonally with respect to a front-rear direction of the vehicle seat 1 such that a lateral frontward portion 112 of the sitting surface 92 to be located closer to the entrance/exit opening 12 of the vehicle is lowered when the sitting surface 92 is tilted.

As a result, a distance from the lateral frontward portion of the vehicle seat (from which a seated person's legs will extend) to a road surface is reduced. Additionally, a bulged portion typically provided on a side portion of the sitting surface of a vehicle seat can be lowered, and a sitting surface angle set in a longitudinal direction of the sitting surface such that a front portion of the sitting surface will be higher can be made smaller. Thus, it is easer for a person sitting on the sitting surface to lift himself or herself off the sitting surface (i.e., get up from the sitting surface) and it is easier for a person to put himself or herself onto the sitting surface than with a vehicle seat that is not configured to move a lateral frontward portion of the sitting surface.

With a conventional structure in which an entire lateral portion of the sitting surface of the vehicle seat is lowered toward the entrance/exit opening, a rearward portion of the sitting surface where a hip point is positioned is also tilted toward the entrance/exit opening. Consequently, the sitting surface cannot be tilted until the sitting person's legs have been placed outside the vehicle cabin. Conversely, with the vehicle seat 1 of the embodiments, since the portion of the sitting surface that is lowered is a lateral frontward portion comprising a portion of a frontward portion of the sitting surface located closer to the entrance/exit opening of the vehicle, it is easier for a sitting person to maintain a sitting posture when the sitting surface is tilted and the person can place his or her legs outside the vehicle cabin after the sitting surface has been tilted.

In addition to improving the ease with which a person sitting on the sitting surface of the vehicle seat can get up from the sitting surface, the vehicle seat according to the embodiments can also improve the ease with which a person can get into the vehicle seat in comparison with a vehicle seat that is not contrived such that a lateral frontward portion moves.

By simply configuring the vehicle seat such that a rotational axis about which the sitting surface tilts is diagonal with respect to a longitudinal direction of the sitting surface, the vehicle seat according to the embodiments can make it easier for a sitting person to move his or her legs out through the entrance/exit opening and easier for the feet of a person getting out of the vehicle to reach the ground without the need to provide a rotation mechanism and a tilt mechanism configured to operate together in a coordinated fashion.

Thus, a vehicle seat according to the vehicle seat according to the embodiments is simpler mechanically and can improve the ease with which a person sitting on the vehicle seat can place his or her feet outside the vehicle.

Since the vehicle seat is simpler mechanically, it can also be configured to be lighter in weight and, thereby, contribute to improving the fuel efficiency of a vehicle in which the vehicle seat is installed.

Since a vehicle seat according to the vehicle seat according to the embodiments does not move to a position outside the vehicle cabin, it is not necessary to open the entrance/exit opening widely and the functions described above can be accomplished even when only a small amount of space is available.

Since the amount of movement of the sitting surface is small in the vehicle seat according to the embodiments, the movement can be completed in a short amount of time and a person can get into and out of the vehicle quickly.

Since the movement direction of the sitting surface is limited to rotation about the aforementioned rotational axis, a strong structure having little excess play can be achieved comparatively easily.

Moreover, the tilting mechanism 24 is configured and arranged to tilt the sitting surface 92 of the vehicle seat 1 from a normal state to a tilted state in which the lateral frontward portion 112 is lower than in the normal state when a door installed in the entrance/exit opening is opened from a closed state, and to tilt the sitting surface 92 of the vehicle seat 1 from the tilted state to the normal state when the door is closed from an open state.

As a result, the ease with which a person can get into and out of the vehicle seat is improved. Meanwhile, when the door is closed from an open state in which it has opened the entrance/exit opening, the tilted sitting surface of the vehicle seat is tilted back to a normal state. In this way, a sitting posture for normal riding is achieved. Since the sitting surface can be tilted and returned in coordination with opening and closing the door, the tilting function can be used without performing such separate operations as turning a switch on and off, thus making the vehicle seat more convenient.

Moreover, the tilting mechanism 24 is configured and arranged to raise a rearward portion 27 of the sitting surface 92 to achieve a tilted state in which the lateral frontward portion 112 of the sitting surface 92 is lower than in a normal state.

In this way, the vehicle seat of the embodiments can be applied to a vehicle in which the sitting surface of the vehicle seat is low and the lateral frontward section cannot be lowered.

Moreover, the seat main body 25 includes a seat cushion 26 forming the sitting surface 92, and the tilting mechanism 24 includes a shaft member 84 arranged along the rotational axis 91 and supporting the seat cushion 26. The shaft member 84 is slanted with respect to a horizontal direction such that one end 201 of the shaft member arranged nearer the entrance/exit opening 12 is positioned higher than the other end 202 of the shaft member 84.

As a result, as the lateral frontward portion 112 of the sitting surface 92 is lowered, a frontward portion of the sitting surface 92 is turned toward the entrance/exit opening 12. In other words, the lateral frontward portion 112 of the sitting surface 92 of the vehicle seat 1 can be turned toward the entrance/exit opening 12 in response to the lateral frontward portion 112 of the sitting surface 92 being lowered. As a result, in comparison with a vehicle seat that requires a person to turn the body by a large amount in order to sit on the sitting surface or exit through the entrance/exit opening, a vehicle seat according to the embodiments can reduce the burden born by the body of a person attempting to sit in the vehicle seat or get out of the vehicle seat because the amount by which the person must rotate his or her body is reduced.

A vehicle according to the embodiments includes the vehicle seat as illustrated in the first or second embodiment, the sliding mechanism (including the slide rails 22) configured and arranged to slide the seat main body 25 in a horizontal direction, the reclining mechanism configured and arranged to recline a seat back of the seat main body, the steering wheel tilt mechanism configured and arranged to change an angle of a steering wheel of the vehicle, and the control device configured to control the sliding mechanism, the reclining mechanism, the steering wheel tilt mechanism in synchronization with the tilting mechanism.

Thus, such existing mechanisms as a sliding mechanism configured to slide a seat main body, a reclining mechanism configured to recline a seat back of the seat main body, and a steering tilt mechanism configured to change an angle of a steering wheel of the vehicle can be controlled when the sitting surface of the vehicle seat is tilted.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle seat. Accordingly, these terms, as utilized to describe the present invention should be interpreted relative to a vehicle seat. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle seat adapted to be disposed adjacent to an entrance/exit opening of a vehicle, the vehicle seat comprising:
a seat main body including a sitting surface; and
a tilting mechanism configured and arranged to selectively tilt the sitting surface about a rotational axis with the rotational axis being arranged diagonally with respect to a front-rear direction of the vehicle seat such that a lateral frontward portion of the sitting surface to be located closer to the entrance/exit opening of the vehicle is lowered when the sitting surface is tilted.

2. The vehicle seat recited in claim 1, wherein
the tilting mechanism is configured and arranged to tilt the sitting surface of the vehicle seat from a normal state to a tilted state in which the lateral frontward portion is lower than in the normal state when a door installed in the entrance/exit opening is opened from a closed state, and to tilt the sitting surface of the vehicle seat from the tilted state to the normal state when the door is closed from an open state.

3. The vehicle seat recited in claim 1, wherein
the tilting mechanism is configured and arranged to raise a rearward portion of the sitting surface to achieve a tilted state in which the lateral frontward portion of the sitting surface is lower than in a normal state.

4. The vehicle seat recited in claim 1, wherein
the seat main body includes a seat cushion forming the sitting surface,
the tilting mechanism includes a shaft member arranged along the rotational axis and supporting the seat cushion with the shaft member being slanted with respect to a horizontal direction such that one end of the shaft member arranged nearer the entrance/exit opening is positioned higher than the other end of the shaft member.

5. The vehicle seat recited in claim 2, wherein
the tilting mechanism is configured and arranged to raise a rearward portion of the sitting surface to achieve a tilted state in which the lateral frontward portion of the sitting surface is lower than in a normal state.

6. The vehicle seat recited in claim 5, wherein
the seat main body includes a seat cushion forming the sitting surface,
the tilting mechanism includes a shaft member arranged along the rotational axis and supporting the seat cushion with the shaft member being slanted with respect to a horizontal direction such that one end of the shaft member arranged nearer the entrance/exit opening is positioned higher than the other end of the shaft member.

7. A vehicle comprising:
the vehicle seat recited in claim 1; and
a control device configured to control the tilting mechanism of the vehicle seat in synchronization with a sliding mechanism configured and arranged to slide the seat main body in a horizontal direction, a reclining mechanism configured and arranged to recline a seat back of the seat main body, and a steering wheel tilt mechanism configured and arranged to change an angle of a steering wheel of the vehicle.
